(19) United States
(12) Patent Application Publication
(10) Pub. No.: US 2021/0101160 A1
(43) Pub. Date: Apr. 8, 2021

(54) SPRAY WAND

(71) Applicant: H.D. Hudson Manufacturing Company, Lowell, MI (US)

(72) Inventors: Ronald D. Dorf, Ada, MI (US); Nicholas Lee Martinchek, Grand Rapids, MI (US)

(21) Appl. No.: 17/062,054

(22) Filed: Oct. 2, 2020

Related U.S. Application Data
(60) Provisional application No. 62/910,004, filed on Oct. 3, 2019.

(51) Int. Cl. B05B 1/12; B05B 1/30; B05B 9/01

(52) U.S. Cl. CPC B05B 1/12; B05B 9/01; B05B 1/3013

(57) ABSTRACT

A spray wand for dispensing liquids includes a handheld housing having an elongated outer tube and an inner tube positioned within the outer tube. The inner tube is partially slidable within the outer tube and includes a liquid-tight seal between the inner tube and the outer tube. The spray wand also includes a thumbwheel rotatably secured within a central void in the handheld housing. The inner tube is positioned at least partially within the central void. The thumbwheel has an inner circumferential surface that is threadably engaged with a threaded outer surface of the inner tube. Rotating the thumbwheel in a first direction translates the inner tube toward a distal end of the outer tube, while rotating the thumbwheel in a second direction translates the inner tube away from a distal end of the outer tube, which resultingly adjusts the spray pattern of the liquid exiting the spray wand.

### CROSS REFERENCE TO RELATED APPLICATION

This application claims the benefit of U.S. Provisional Application 62/910,004, which was filed on Oct. 3, 2019, the disclosure of which is hereby incorporated by reference.

### BACKGROUND OF THE INVENTION

### 1. Field of the Invention

The present invention pertains to a spray wand suitable for dispensing a liquid. More particularly, the present invention pertains to a spray wand having an outer tube and an inner tube disposed inside the outer tube, and the inner tube is adapted to slide relative to the outer tube to change the spray pattern of the liquid exiting the spray wand.

### 2. Description of the Prior Art

A spray wand is typically used for dispensing liquids, such as fertilizers, pesticides, herbicides, and cleaning chemicals. The spray wand, generally, includes a nozzle for spraying liquids in a desired spray pattern. To alter the spray pattern of the liquid exiting the nozzle, the nozzle is manually rotated by an operator. More specifically, threading or rotating the nozzle further onto the end of the spray wand creates a wider spray pattern, while rotating the nozzle away from the end of the spray wand creates a narrower and more stream-like pattern. While rotating the nozzle, the hand of the operator often comes into contact with the liquid being dispensed, which is undesirable.

### SUMMARY OF THE INVENTION

According to an aspect of the disclosure a spray wand for dispensing liquids is disclosed. The spray wand includes a handheld housing having a handle, a shutoff valve, and an elongated outer tube. The spray wand further includes an inner tube that is positioned within the outer tube. The inner tube is partially slidable within the outer tube and includes a liquid-tight gasket at a distal end for creating a watertight seal between the inner tube and the outer tube. Also, an outer surface of the inner tube is threaded at a proximal end. Furthermore, the spray wand includes an adjusting member for creating a relative sliding movement between the outer tube and the inner tube, whereby the adjusting member is configured to selectively change a spray pattern of the liquid dispensed from the spray wand thumbwheel that is rotatably secured within the handheld housing. In one embodiment, the adjusting member is a thumbwheel having a central void and the inner tube is positioned at least partially within, and extends through, the central void. The thumbwheel also has an inner circumferential surface that is threaded and configured to be threadably engaged with the threaded outer surface of the inner tube. Furthermore, rotating the thumbwheel within the handheld housing in a first direction of rotation translates the inner tube toward the distal end of the outer tube, and rotating the thumbwheel within the handheld housing in a second direction of rotation translates the inner tube away from the distal end of the outer tube.

According to another aspect of the disclosure, there is provided a spray wand for dispensing a liquid comprising a handheld housing having an elongated outer tube, an inner tube that is positioned within the outer tube, and an adjusting member configured to create a relative sliding movement between the outer tube and the inner tube, whereby the adjusting member is configured to selectively change a spray pattern of the liquid dispensed from the spray wand. Optionally, the outer tube is threaded on an inner surface and the inner tube is threaded on an outer surface, and the outer tube is slidable with respect to the inner tube, whereby rotating the outer tube causes the outer tube to slide with respect to the inner tube. Alternatively, and optionally, the inner tube is slidable within the outer tube, a portion of the inner tube includes exterior threads, and the adjusting member is a threaded thumbwheel which threadingly engages with the exterior threads on the inner tube, whereby rotating the thumbwheel causes the inner tube to slide within the outer tube.

According to yet another aspect of the disclosure, there is provided a spray wand for dispensing liquids comprising: a handheld housing including a handle, a shutoff valve, and an elongated outer tube; an inner tube that is positioned within the outer tube, the inner tube being partially slidable within the outer tube, the inner tube including a liquid-tight gasket at a distal end thereof for creating a watertight seal between the inner tube and the outer tube, and an outer surface of the inner tube being threaded at a proximal end thereof; and an adjusting member configured to create a relative sliding movement between the outer tube and the inner tube; wherein a first manipulation of the adjusting member selectively translates the inner tube toward a distal end of the outer tube, and wherein a second manipulation of the adjusting member selectively translates the inner tube away from a distal end of the outer tube.

Pursuant to this aspect of the disclosure, the adjusting member may optionally comprise a thumbwheel that is rotatably secured within the handheld housing, the thumbwheel having a central void and the inner tube is positioned at least partially within the central void, the thumbwheel having an inner circumferential surface that is threaded and configured to be threadably engaged with the threaded outer surface of the inner tube; wherein rotating the thumbwheel within the handheld housing in a first direction of rotation translates the inner tube toward a distal end of the outer tube, and wherein rotating the thumbwheel within the handheld housing in a second direction of rotation translates the inner tube away from a distal end of the outer tube.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 illustrates a front view of a spray wand, in accordance with an embodiment of the disclosure;

FIG. 2 illustrates a sectional view of the spray wand of FIG. 1 depicting a second end of the inner tube disposed proximate to a housing spray orifice, in accordance with an embodiment of the disclosure;

FIG. 3 illustrates a sectional view of the spray wand of FIG. 1 depicting the second end of the inner tube disposed relatively away from the housing spray orifice, in accordance with an embodiment of the disclosure;

FIG. 4 illustrates a front perspective view of a thumbwheel of the spray wand of FIG. 1, in accordance with an embodiment of the disclosure; and

FIG. 5 illustrates a sectional view of the spray wand having an alternate embodiment.

### DETAILED DESCRIPTION OF A PREFERRED EMBODIMENT

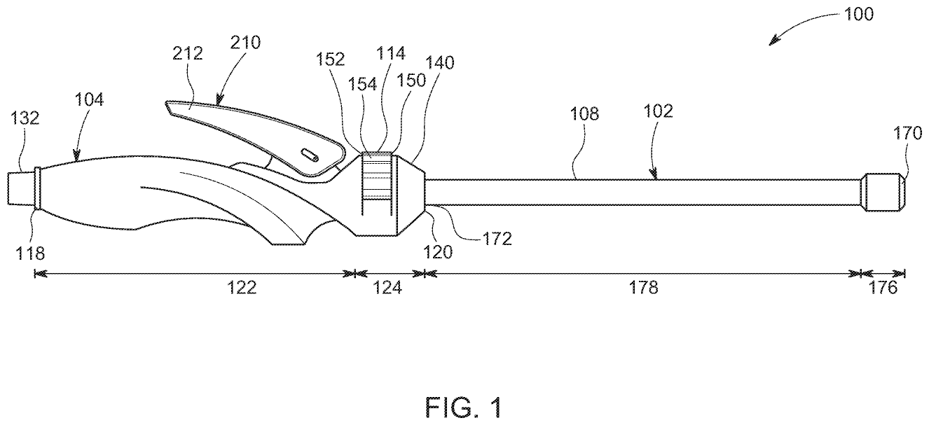

Referring to FIGS. 1, 2, and 3, an exemplary spray wand 100 suitable for dispensing liquids is shown. The spray wand 100 includes a handheld housing 102 (hereinafter referred to as a housing 102) having a handle 104, an elongated outer tube 108 extending outwardly from the handle 104 along a longitudinal direction of the handle 104, an inner tube 110 disposed, at least partly, within the outer tube 108, and an adjusting member, such as a thumbwheel 114, engaged with the inner tube 110 and adapted to control a sliding movement of the inner tube 110 within the outer tube 108. The handle 104 may include a substantially cylindrical shape, and may include a first longitudinal end 118, a second longitudinal end 120, a first portion 122, and a second portion 124 extending from the first portion 122 to the second longitudinal end 120. In an embodiment, the first portion 122 may extend from the first longitudinal end 118 to the second portion 124 along a longitudinal axis 126 of the spray wand 100, and may define an elongated channel 130 extending longitudinally from the first longitudinal end 118 to the second portion 124. The elongated channel 130 provides a passageway for the liquid received from a liquid reservoir 300, which is preferably pressurized. The elongated channel 130 may include an inlet 132 at the first longitudinal end 118 to receive the liquid from the liquid reservoir 300. In an embodiment, the inlet 132 may be in a fluid communication with the liquid reservoir 300 via a conduit 302. Furthermore, an outer surface 134 of the first portion 122 may include a grip for holding the spray wand 100.

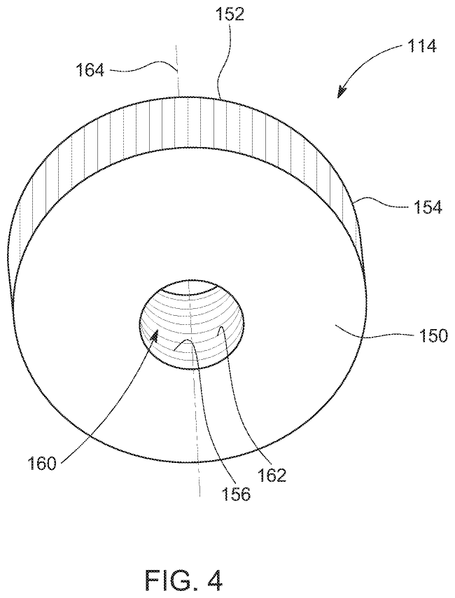

The second portion 124 may include a chamber 136 for receiving a portion of the inner tube 110 and the thumbwheel 114. In an embodiment, the second portion 124 may include a wall 140 that defines an opening 142 extending through the wall 140 from an outer surface 144 of the second portion 124 to the inner surface 146 of the second portion 124. The opening 142 facilitates an extension of a portion of the thumbwheel 114 outside of the second portion 124 (i.e. the handle 104). As shown in FIG. 4, the thumbwheel 114 may be in the form of a circular disk, or wheel, having a first end surface 150, a second end surface 152, an outer circumferential surface 154, and an inner circumferential surface 156 defining a central void 160 of the thumbwheel 114. The first end surface 150 and the second end surface 152 may abut the wall 140 of the second portion 124 to prevent a linear movement of the thumbwheel 114 in the longitudinal direction of the spray wand 100. Furthermore, the thumbwheel 114 includes threads 162 (hereinafter referred to as first threads 162) to threadably engage the thumbwheel 114 with the inner tube 110. The thumbwheel 114 is adapted to rotate within the chamber 136 about a central axis 164 of the thumbwheel 114. In response to a rotation of the thumbwheel 114 inside the chamber 136, the inner tube 114 moves/slides linearly along the longitudinal axis 126 of the spray wand 100.

Furthermore, the outer tube 108 is coupled to the second portion 124 and extends outwardly from the second portion 124. In an embodiment, the outer tube 108 has a first end 170 and a second end 172 coupled to the second portion 124. In an embodiment, the outer tube 108 is removably coupled to the second portion 124 (i.e. the handle 104) and may include a threaded portion for facilitating a removable coupling/attachment/engagement of the outer tube 108 with the handle 104. Furthermore, the outer tube 108 may include a first portion 176 and a second portion 178 extending from the first portion 176 to the second end 172. The first portion 176 extends from the first end 170 to the second portion 178, and includes a first diameter “D1” greater than a diameter (hereinafter referred to as a second diameter “D2”) of the second portion 178. Further, the first portion 176 may include a housing spray orifice 180 to facilitate the exit of liquids received from the inner tube 110 to an ambient.

The inner tube 110 is positioned, at least partly, within the outer tube 108, and slides and reciprocates within the outer tube 108 along a longitudinal direction of the spray wand 100. The inner tube 110 includes a first end 182 (also referred to as proximal end) disposed inside the elongated channel 130 and a second end 184 (distal end) positioned inside the first portion 176 of the outer tube 108. Preferably, the inner tube 110 is coupled to the elongated channel 130 by inserting a portion of the inner tube 110 inside the elongated channel 130. The inner tube 110 is adapted to receive the liquid from the elongated channel 130 and provides a passage for the liquid received from the elongated channel 130 to an inner tube spray orifice disposed at the second end 184 of the inner tube 110. The inner tube 110 also includes a liquid-tight gasket 192 (hereinafter referred to as a first seal 192) disposed proximate to the second end 184 of the inner tube 110, and a second seal 194 disposed proximate to an inlet or the first end 182 of the inner tube 110. The first seal 192 is mounted on the inner tube 110 and is located between the inner tube 110 and the outer tube 108 such that an inner periphery of the first seal 192 contacts/abuts an outer surface of the inner tube 110 and an outer periphery of the first seal 192 contacts/abuts an inner surface the first portion 176 or an inner surface of the second portion 178 of the outer tube 108. Preferably, the first seal 192 is an O-ring and is adapted to provide a watertight seal between the inner tube 110 and the outer tube 108 to prevent a leakage of the liquid from the first portion 176 of the outer tube 108 to a gap defined between the inner tube 108 and the second portion 178 of the outer tube 108. Similar to first seal 192, the second seal 194 is mounted on the inner tube 108, and prevents a leakage of the liquid from the elongated channel 130 to the chamber 136. Accordingly, the second seal 194 is disposed between the inner tube 110 and the elongated channel 130. Preferably, the second seal 194 is an O-ring, and an inner periphery of the second seal 194 contacts/abuts the outer surface of the inner tube 110, while an outer periphery of the second seal 194 contacts/abuts an inner surface of the elongated channel 130.

The inner tube 108 also includes a threaded portion 196 disposed along the length of the inner tube 108 positioned inside the chamber 136. The inner tube 108 is movably engaged with the first threads 162 on the inner circumferential surface 156 of the thumbwheel 114. The threaded portion 196 has a threaded outer surface 198 of the inner tube 110 and includes one or more threads 200 (hereinafter referred to as second threads 200). The engagement of the first threads 162 and the second threads 200 enables the linear movement, or the sliding, of the inner tube 110 in response to the rotation of the thumbwheel 114 about the central axis 164. Preferably, the inner tube 110 slides/moves toward the housing tube orifice 180 when the thumbwheel 114 is rotated in a first direction “A,” while a movement of the thumbwheel 114 in a second direction “B” (opposite to the first direction “A”) causes a sliding/movement of the inner tube 110 away from the housing tube orifice 180. In this manner, the distance between the inner tube orifice (of the inner tube 110) and the housing tube orifice 180 is varied, which in turn, changes the spray pattern of the liquid exiting the housing tube orifice 180. For example, the spray pattern changes from a spray pattern having a narrow spray width to a spray pattern having wider spray width as the inner tube orifice or the second end 184 moves toward the housing tube orifice 180. Similarly, the spray pattern changes from a spray pattern having a wider spray width to a spray pattern having a narrow spray width as the inner tube orifice or the second end 184 moves away from the housing tube orifice 180. In some embodiments, the inner tube 110 may include a diffuser 202 attached to the second end 184 of the inner tube 110 to facilitate an exit of the liquid in the form of a spray from the inner tube 110.

In addition, alternate embodiments or other means for sliding the inner tube 110 can be provided to facilitate a user to slide the inner tube 110 within the outer tube 108 in order to adjust the spray pattern. For example, an alternate embodiment could include a thumb grip or finger grip (not shown) secured directly to the inner tube 110 and extending partially out of the housing 102. In this alternate embodiment, the user simply places his or her finger (or thumb) directly on the thumb grip or finger grip to slide the grip (and hence, the inner tube 110) in the longitudinal direction of the inner tube 110 either toward or away from the first end 170 of the outer tube 108. Furthermore, any other suitable type of means for sliding the inner tube 110 may be used.

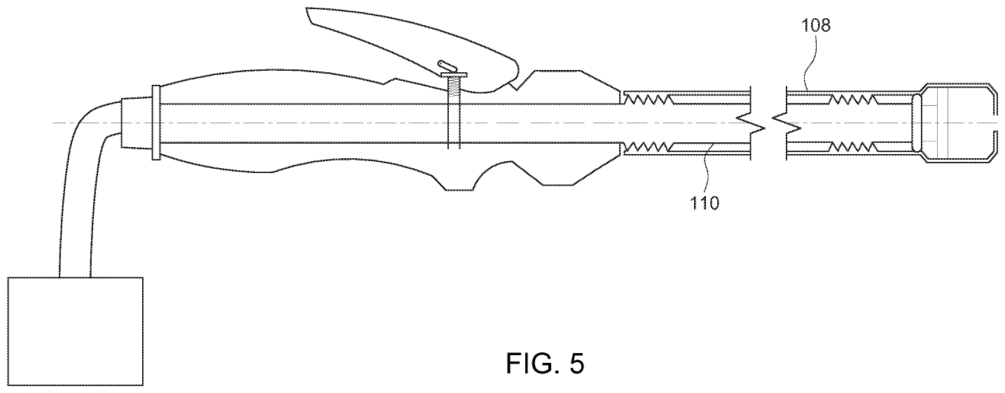

As shown in FIG. 5 in an alternate embodiment, the outer tube 108 is threaded on an inner surface thereof, and the inner tube 110 is threaded on an outer surface thereof. In addition, the outer tube 108 is slidable with respect to the inner tube 110, whereby rotating the outer tube 108 causes the outer tube 108 to slide with respect to the inner tube 110 as the inner tube 110 and outer tube 108 and their respective threads are rotated with respect to one another.

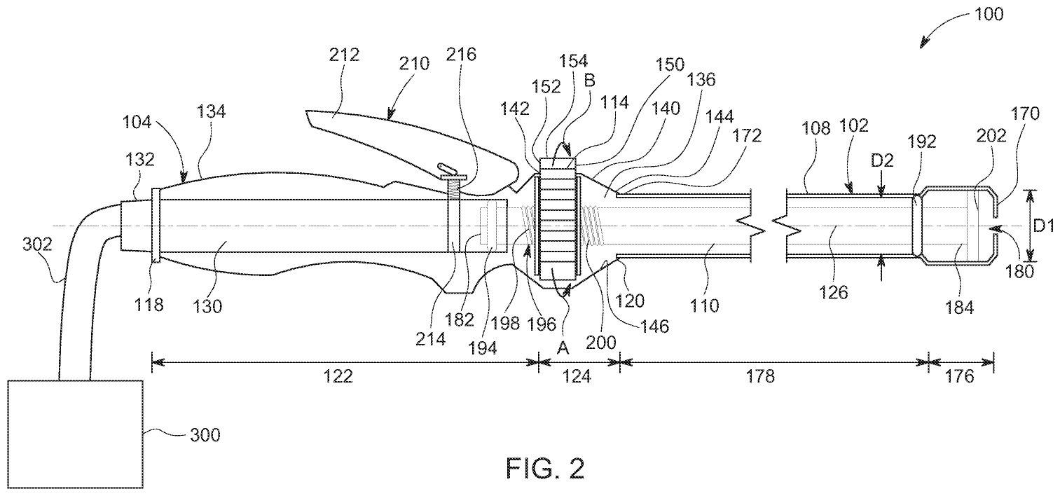

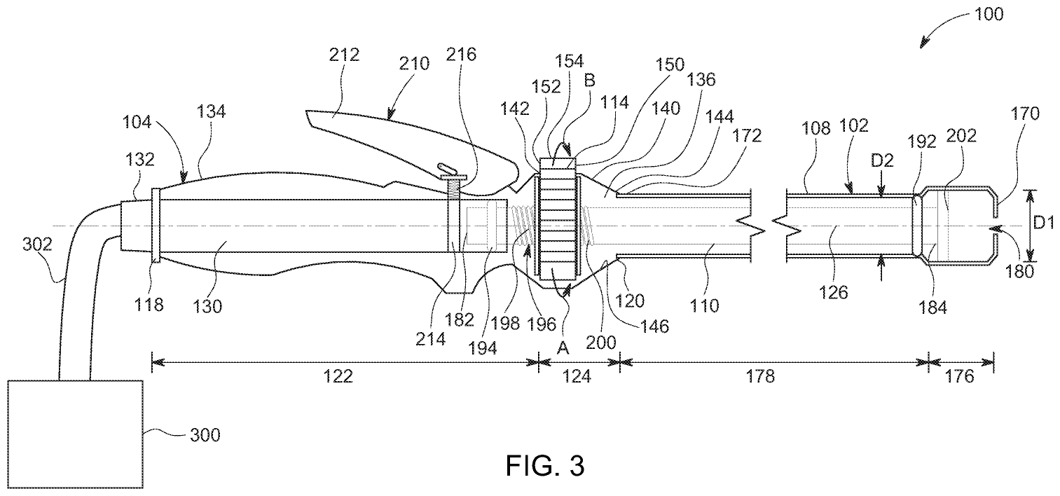

Furthermore, referring back to FIG. 4, the spray wand 100 includes a shut-off valve 210 to control a flow of liquid from the liquid reservoir 300 to the housing tube orifice 180. The valve 210 is preferably disposed upstream of the inner tube 110 and downstream of the inlet 132 of the elongated channel 130. In an embodiment, the valve 210 is a manually operated valve and may be operated or actuated to a first position and a second position, and is of the type of shut-off valve that is well-known in the prior art for use with spray wands. In the first spring-biased position, the valve 210 is adapted to prevent a flow of the liquid from the elongated channel 130 to the inner tube 110, while in the second position, the valve 210 is adapted to allow the flow of the liquid from the elongated channel 130 to the inner tube 110. Preferably the valve 210 includes a manually operated lever 212 for moving the valve 210 between the first position and the second position. In an implementation, as shown in FIGS. 2 and 3, the valve 210 may include a stem 214 having an orifice (not shown) coupled to the lever 212 and adapted to slide or move inside the elongated channel 130 to allow or prevent the flow of liquid from the elongated channel 130 to the inner tube 110. In the first position of the valve 210, the stem 214 may be partially retracted such that the orifice does not align with the elongated channel 130 so as to block or prevent the flow of liquid from the inlet 132 to the housing tube orifice 180. Conversely, while in the second position of the valve 210, the stem 214 may extend inside the elongated channel 130 to align the orifice with the channel 130, so as to allow the flow of liquid from the inlet 132 to the housing tube orifice 180. Although not shown in the drawings, the stem 214 may optionally include a disk-shaped structure. In such a case, the disk-shaped structure may be disposed normal to the flow of liquid when the valve 210 is in the first position, while the disk-shaped structure may be disposed parallel to the flow of liquid when the valve 210 is in the second position. Furthermore, the valve 210 may be biased to the first position by a biasing member 216, such as a spring. In such a case, a person may operate and hold the lever 212 to move the valve 210 to the second position, and the valve 150 may move to the first position when the lever 212 is released by the operator. Although a manually actuated first valve 210 as described above is contemplated, any other suitable types of valves which are well-known to one having ordinary skill in the art may be used, such as an electromechanical valve, hydromechanical valve, electrohydraulic valve, and so forth.

In use, the operator engages together the inlet 132 of the elongated channel 130, the conduit 302, and the liquid reservoir 300, such as a tank. The operator then pressurizes the contents of the liquid reservoir 300 and operates the lever 212 to move the valve 210 to the second position, thereby allowing the liquid to flow from the inlet 132 to the diffuser 202, and hence the housing tube orifice 180 via the elongated channel 130 and the inner tube 110. The diffuser 202 sprays the liquid inside the first portion 176, and the liquid, subsequently, exits the outer tube 108 to the ambient through the housing tube orifice 180 as a first spray pattern.

In an exemplary embodiment (shown in FIG. 2), initially, the second end 184 of the inner tube 110, and hence the diffuser 200, is disposed proximate to the housing tube orifice 180. In such a case, the spray pattern of the liquid exiting the spray wand 100 is wide and diffused. To decrease the spray width of the liquid exiting the spray wand 100, and hence to change the spray pattern, the operator rotates the thumbwheel 114 in the second direction “B,” resulting in a movement of the second end 184 of the inner tube 110 away from the housing tube orifice 180. As the distance between the second end 184 (or the inner tube orifice) and the housing tube orifice 180 increases (as shown in FIG. 3), the spray width of the liquid exiting the housing tube orifice 180 (i.e. the spray wand 100) narrows. Thus, a user can adjust the spray pattern (i.e. the spray width) without touching the housing tube orifice 180, thereby preventing contact of the liquid with the hands of the operator.

It should be understood that the foregoing description is only illustrative of the aspects of the disclosed embodiments. Various alternatives and modifications can be devised by those skilled in the art without departing from the aspects of the disclosed embodiments. Accordingly, the aspects of the disclosed embodiments are intended to embrace all such alternatives, modifications, and variances that fall within the scope of the appended claims. Further, the mere fact that different features are recited in mutually different dependent or independent claims does not indicate that a combination of these features cannot be advantageously used, such as a combination remaining within the scope of the aspects of the disclosed embodiments.

What is claimed is:

1. A spray wand for dispensing liquids comprising:
a handheld housing including a handle, a shutoff valve, and an elongated outer tube;
an inner tube that is positioned within the outer tube, the inner tube being partially slidable within the outer tube, the inner tube including a liquid-tight gasket at a distal end thereof for creating a watertight seal between the inner tube and the outer tube, and an outer surface of the inner tube being threaded at a proximal end thereof; and
a thumbwheel that is rotatably secured within the handheld housing, the thumbwheel having a central void and the inner tube is positioned at least partially within the central void, the thumbwheel having an inner circumferential surface that is threaded and configured to be threadably engaged with the threaded outer surface of the inner tube;
wherein rotating the thumbwheel within the handheld housing in a first direction of rotation translates the inner tube toward a distal end of the outer tube, and wherein rotating the thumbwheel within the handheld housing in a second direction of rotation translates the inner tube away from a distal end of the outer tube.

2. The spray wand of claim 1 wherein the distal end of the outer tube includes a housing spray orifice, and the distal end of the inner tube includes an inner tube spray orifice.

3. The spray wand of claim 2 wherein the spray pattern of liquid exiting the inner tube spray orifice and the housing spray orifice is determined by the distance between the inner tube spray orifice and the housing spray orifice.

4. The spray wand of claim 3 wherein the spray pattern of liquid exiting the inner tube spray orifice and the housing spray orifice is configured to be adjusted by rotating the thumbwheel.

5. A spray wand for dispensing a liquid comprising:
a handheld housing having an elongated outer tube;
an inner tube that is positioned within the outer tube; and
an adjusting member configured to create a relative sliding movement between the outer tube and the inner tube, whereby the adjusting member is configured to selectively change a spray pattern of the liquid dispensed from the spray wand.

6. The spray wand of claim 5 wherein the outer tube is threaded on an inner surface and the inner tube is threaded on an outer surface, and the outer tube is slidable with respect to the inner tube, whereby rotating the outer tube causes the outer tube to slide with respect to the inner tube.

7. The spray wand of claim 5 wherein the inner tube is slidable within the outer tube, a portion of the inner tube includes exterior threads, and the adjusting member is a threaded thumbwheel which threadingly engages with the exterior threads on the inner tube, whereby rotating the thumbwheel causes the inner tube to slide within the outer tube.

8. A spray wand for dispensing liquids comprising:
a handheld housing including a handle, a shutoff valve, and an elongated outer tube;
an inner tube that is positioned within the outer tube, the inner tube being partially slidable within the outer tube, the inner tube including a liquid-tight gasket at a distal end thereof for creating a watertight seal between the inner tube and the outer tube, and an outer surface of the inner tube being threaded at a proximal end thereof; and
an adjusting member configured to create a relative sliding movement between the outer tube and the inner tube;
wherein a first manipulation of the adjusting member selectively translates the inner tube toward a distal end of the outer tube, and wherein a second manipulation of the adjusting member selectively translates the inner tube away from a distal end of the outer tube.

9. The spray wand of claim 8 wherein the adjusting member comprises a thumbwheel that is rotatably secured within the handheld housing, the thumbwheel having a central void and the inner tube is positioned at least partially within the central void, the thumbwheel having an inner circumferential surface that is threaded and configured to be threadably engaged with the threaded outer surface of the inner tube; wherein rotating the thumbwheel within the handheld housing in a first direction of rotation translates the inner tube toward a distal end of the outer tube, and wherein rotating the thumbwheel within the handheld housing in a second direction of rotation translates the inner tube away from a distal end of the outer tube.

10. The spray wand of claim 9 wherein the distal end of the outer tube includes a housing spray orifice, and the distal end of the inner tube includes an inner tube spray orifice.

11. The spray wand of claim 10 wherein the spray pattern of liquid exiting the inner tube spray orifice and the housing spray orifice is determined by the distance between the inner tube spray orifice and the housing spray orifice.

12. The spray wand of claim 11 wherein the spray pattern of liquid exiting the inner tube spray orifice and the housing spray orifice is configured to be adjusted by rotating the thumbwheel.

13. The spray wand of claim 8 wherein the shutoff valve includes a manually operated lever for moving the valve shutoff between a first position and a second position.

14. The spray wand of claim 13 wherein the shutoff valve includes a spring for biasing the lever in the first position, and the shutoff valve is configured to prevent the spray wand from dispensing liquids when the lever is in the first position.

15. The spray wand of claim 9 wherein the shutoff valve includes a manually operated lever for moving the valve shutoff between a first position and a second position.

16. The spray wand of claim 15 wherein the shutoff valve includes a spring for biasing the lever in the first position, and the shutoff valve is configured to prevent the spray wand from dispensing liquids when the lever is in the first position.
